(19) United States
(12) Patent Application Publication
(10) Pub. No.: US 2024/0327752 A1
(43) Pub. Date: Oct. 3, 2024

(54) ANTIMICROBIAL LIQUID DETERGENT COMPOSITION

(71) Applicant: The Procter & Gamble Company, Cincinnati, OH (US)

(72) Inventors: Karl Ghislain BRAECKMAN, Gerpinnes (DK); Misbah Kosar GHAFOOR, Reading (GB); Robby Renilde François KEULEERS, Puurs-Sint-Amands (BE); Kelly Paula August MERCKX, Brussels (BE); Mary Teresa MORAN, London (GB)

(21) Appl. No.: 18/621,222

(22) Filed: Mar. 29, 2024

(30) Foreign Application Priority Data
Mar. 31, 2023 (EP) 23165780.0
Jan. 26, 2024 (EP) 24154068.1

(51) Int. Cl. C11D 1/14; C11D 1/72; C11D 1/83; C11D 1/90; C11D 1/94; C11D 3/20; C11D 17/08

(52) U.S. Cl. CPC C11D 1/146; C11D 1/143; C11D 1/72; C11D 1/83; C11D 1/90; C11D 1/94; C11D 3/2086; C11D 17/08; C11D 2111/14

(57) ABSTRACT

A liquid hand dishwashing detergent composition includes from about 5% to about 50% by weight of the total composition of a surfactant system. The surfactant system includes anionic surfactant having at least about 50% by weight of the anionic surfactant of alkyl sulfated anionic surfactant. The alkyl sulfated anionic surfactant has an average degree of alkoxylation of about 1.0 or less, and the alkyl sulfated anionic surfactant has a weight average degree of branching of at least about 15%. The surfactant system further includes an alkyl polyglucoside surfactant. The composition further includes a carboxylic acid and/or a salt thereof; and the composition has a pH of less than about 5.0, measured as an about 10% solution in demineralized water at about 20° C.

### TECHNICAL FIELD

The present disclosure relates to liquid hand dishwashing compositions and methods of cleaning dishes.

### BACKGROUND

During manual dishwashing, effective foaming and rinsing of the foam is important for consumers. Long lasting foam during the washing step signals cleaning effectiveness to the consumer. To provide good foaming and cleaning benefits, formulators of hand dishwashing detergent compositions have traditionally formulated with anionic surfactants, including alkyl ethoxylate sulphated anionic surfactants.

There is an additional desire amongst some users that liquid hand dishwashing compositions provide greater disinfection, in addition to cleaning and sudsing. As such, liquid hand dishwashing compositions can be formulated with antimicrobial agents. The antimicrobial agent is desirably suitable for use on surfaces that come into contact with food, and ideally leaves little residue after the cleaning process has been completed.

The lactic acid exhibits antimicrobial efficacy while being suitable for use in liquid hand dishwashing compositions, when used in compositions having an acidic pH. It has also been found that antimicrobial efficacy of such compositions can be improved when formulated using linear alkyl sulfate anionic surfactants having a low degree of alkoxylation, or being free of alkoxylation. However, such compositions have been found to be less physically stable, especially at low temperatures.

However, there remains a need to improve the antimicrobial efficacy of liquid hand dishwashing compositions comprising lactic acid, while also improving the physical stability of such compositions, especially at low temperatures.

WO2016118728A relates to a cleaning composition for dishwashing including an alkoxylated polyethylenimine and a surfactant actives component, the surfactant actives component includes an anionic surfactant, an additional surfactant, a betaine, and an amine oxide. US20140336094A1 relates to a cleaning composition, useful for dishwashing, which comprises anionic surfactant, nonionic surfactant, and lactic acid, the composition having a pH of no greater than 4, as well as a method of forming the composition comprising the steps of combining the anionic and nonionic surfactants to form a first solution, and combining a supplemental acid different from lactic acid with the first solution to form a second solution, the second solution has a pH of no greater than 5, the method further comprising the step of combining the lactic acid and second solution to form the composition. EP4095221A relates to cleaning compositions that include renewable components and fewer components, compared to traditional cleaning compositions, while providing comparable or better performance than traditional cleaning compositions. US2011092407A, U.S. Pat. Nos. 8,247,362B2, 8,309,504B2, 7,718,595B2, US2009312226, US8022028B2 relate to liquid cleaning compositions, for example, dish washing liquids, and methods of their manufacture and use, which possess enhanced cleaning ability, the cleaning compositions include acidic light duty liquid cleaning compositions with low toxicity and antibacterial efficacy on surfaces, for example, hard surfaces. U.S. Pat. No. 7,449,436B2 relates to a light duty liquid cleaning composition comprising at least one ammonium or metal salt of a C8-C16 linear alkyl benzene sulfonate surfactant, at least one ammonium or metal salt of an ethoxylated C8-C18 alkyl ether sulfate surfactant having 1 to 30 moles of ethylene oxide, and at least one betaine surfactant, the composition has a pH less than 7 and a viscosity of less than 75 cPs measured at 25° C. U.S. Pat. No. 6,884,764B2 relates to a liquid dish cleaning composition comprising a C8-18 ethoxylated alkyl ether sulfate, two anionic surfactant, a betaine surfactant, an alkyl polyglucoside surfactant, a hydroxy containing organic acid, and water. U.S. Pat. No. 6,586,014B2 relates to an antibacterial liquid dish cleaning composition with desirable cleansing and de-staining properties comprising a C8-18 ethoxylated alkyl ether sulfate, two anionic surfactant, a betaine surfactant, a hydroxy containing organic acid, polyethylene glycol, hydrogen peroxide and water. U.S. Pat. No. 6,251,844B1 relates to a light duty liquid detergent with desirable cleansing properties to the human skin comprising a C8-18 ethoxylated alkyl ether sulfate anionic surfactant, a sulfonate anionic surfactant, polyethylene glycol, a zwitterionic surfactant, a hydroxy aliphatic acid and water. EP1492862B1 relates to a color stable liquid dish cleaning composition with desirable cleansing and destaining properties comprising a C8-18 ethoxylated alkyl ether sulfate, two anionic surfactants, a betaine surfactant, hydrogen peroxide, a colorant, a hydroxy containing organic acid, polyethylene glycol.

EP3971270A relates to a liquid hand dishwashing cleaning compositions that comprise alkyl sulfate anionic surfactant having little or no ethoxylation, which provides improved low temperature stability while also achieving the desired product viscosity, suds mileage and overall cleaning. EP3971271A relates to a hand-dishwashing composition which is highly effective at removing grease, providing long-lasting suds under soiled conditions, while having a Newtonian viscosity which is less sensitive to changes on surfactant and solvent levels, the liquid hand dishwashing cleaning composition comprising a surfactant system having a combination of alkyl sulphate anionic surfactant having little or no alkoxylation and an alkyl polyglucoside surfactant. EP3971273A relates to a hand-dishwashing composition which is highly effective at removing grease, while also having good suds mileage, and avoiding negatives on physical stability, especially at low temperatures, the hand dishwashing composition comprising a surfactant system, the surfactant system comprising an alkyl sulfate anionic surfactant comprising little or no branching and having a low degree of alkoxylation, or no alkoxylation, and a co-surfactant, in combination with polypropylene glycol of a defined molecular weight, as described herein. EP3919594A relates to a liquid detergent composition suitable for washing dishes, fitting both in-sink as well as direct application habits, which provides reduced smearing when used in direct application dishwashing methods, while having good suds mileage especially under in-sink application habit, and good viscosity, the liquid detergent composition comprises a surfactant system, which comprises an alkyl sulfate anionic surfactant comprising C13 alkyl sulfate anionic surfactant, the C13 alkyl sulfate anionic surfactant comprising a specific fraction of 2-branched C13 alkyl sulfate anionic surfactant, with a specific distribution of the 2-branching. EP3971275A relates to a hand-dishwashing composition which is highly effective at emulsifying grease, the liquid hand dishwashing cleaning composition comprising a surfactant system having a combination of alkyl sulphate anionic surfactant and a co-surfactant comprising at least 70% by weight of the co-surfactant of a betaine, in combination with a polypropyleneglycol having a weight average molecular weight from 500 g/mol to 1800 g/mol.

### SUMMARY

The present disclosure relates to a liquid hand dishwashing composition comprising: from 5% to 50% by weight of the total composition of a surfactant system, wherein the surfactant system comprises: anionic surfactant, wherein the anionic surfactant comprises at least 50% by weight of the anionic surfactant of alkyl sulfated anionic surfactant, wherein the alkyl sulfated anionic surfactant has an average degree of alkoxylation of 1.0 or less, the alkyl sulfated anionic surfactant has a weight average degree of branching of at least 15%; and an alkyl polyglucoside surfactant, the composition further comprises a carboxylic acid and/or a salt thereof, wherein the carboxylic acid and/or a salt thereof comprises lactic acid and/or a salt thereof; and the composition has a pH of less than 5.0, measured as a 10% solution in demineralized water at 20° C.

The present disclosure further relates to a method of cleaning dishes, the method comprising the step of contacting dishware with a liquid hand dishwashing detergent composition as described herein.

### DETAILED DESCRIPTION

It has been found that liquid hand dishwashing detergents comprising alkyl sulfated anionic surfactant, an alkyl polyglucoside surfactant, and carboxylic acid and/or a salt thereof comprising lactic acid and/or a salt thereof, as described herein, provide both good foaming, grease cleaning and physical stability at low temperatures, as well as an improved composition with robust antimicrobial efficacy delivered by lactic acid.

### Definitions

As used herein, articles such as “a” and “an” when used in a claim, are understood to mean one or more of what is claimed or described.

The term “comprising” as used herein means that steps and ingredients other than those specifically mentioned can be added. This term encompasses the terms “consisting of” and “consisting essentially of.” The compositions of the present disclosure can comprise, consist of, and consist essentially of the essential elements and limitations of the compositions and/or methods described herein, as well as any of the additional or optional ingredients, components, steps, or limitations described herein.

The term “dishware” as used herein includes cookware and tableware made from, by non-limiting examples, ceramic, china, metal, glass, plastic (e.g., polyethylene, polypropylene, polystyrene, etc.) and wood.

The term “grease” or “greasy” as used herein means materials comprising at least in part (i.e., at least 0.5 wt % by weight of the grease) saturated and unsaturated fats and oils, preferably oils and fats derived from animal sources such as beef, pig and/or chicken.

The terms “include”, “includes” and “including” are meant to be non-limiting.

The term “particulate soils” as used herein means inorganic and especially organic, solid soil particles, especially food particles, such as for non-limiting examples: finely divided elemental carbon, baked grease particle, and meat particles.

The term “sudsing profile” as used herein refers to the properties of a cleaning composition relating to suds character during the dishwashing process. The term “sudsing profile” of a cleaning composition includes suds volume generated upon dissolving and agitation, typically manual agitation, of the cleaning composition in the aqueous washing solution, and the retention of the suds during the dishwashing process. Preferably, hand dishwashing cleaning compositions characterized as having “good sudsing profile” tend to have high suds volume and/or sustained suds volume, particularly during a substantial portion of or for the entire manual dishwashing process. This is important as the consumer uses high suds as an indicator that sufficient cleaning composition has been dosed. Moreover, the consumer also uses the sustained suds volume as an indicator that sufficient active cleaning ingredients (e.g., surfactants) are present, even towards the end of the dishwashing process. The consumer usually renews the washing solution when the sudsing subsides. Thus, a low sudsing cleaning composition will tend to be replaced by the consumer more frequently than is necessary because of the low sudsing level.

It is understood that the test methods that are disclosed in the Test Methods Section of the present application may be used to determine the respective values of the parameters of Applicants' compositions as described and claimed herein.

In all embodiments of the present disclosure, all percentages are by weight of the total composition, as evident by the context, unless specifically stated otherwise. All ratios are weight ratios, unless specifically stated otherwise, and all measurements are made at 25° C., unless otherwise designated.

### Cleaning Composition

The cleaning composition is a liquid hand dishwashing cleaning composition. The cleaning composition is preferably an aqueous cleaning composition. As such, the composition can comprise from 50% to 85%, preferably from 50% to 75%, by weight of the total composition of water.

The pH of the composition is less than 5.0, preferably from 2.0 to less than 5.0, more preferably from 3.0 to 4.0, measured as a 10% solution in demineralized water at 20° C.

The composition of the present disclosure can be Newtonian or non-Newtonian, preferably Newtonian in the usage shear rate range of from 0.1 s⁻¹ to 100 s⁻¹. Preferably, the composition has a viscosity of from 10 mPa·s to 10,000 mPa·s, preferably from 100 mPa·s to 5,000 mPa·s, more preferably from 300 mPa·s to 2,000 mPa·s, or most preferably from 500 mPa·s to 1,500 mPa·s, alternatively combinations thereof. The viscosity is measured at 20° C. with a Brookfield RT Viscometer using spindle 31 with the RPM of the viscometer adjusted to achieve a torque of between 40% and 60%.

### Surfactant System

The cleaning composition comprises from 5.0% to 50%, preferably from 8.0% to 45%, more preferably from 15% to 40%, by weight of the total composition of a surfactant system.

### Anionic Surfactant:

The liquid hand dishwashing detergent composition comprises a surfactant system, wherein the surfactant system comprises an anionic surfactant system comprising alkyl sulfated anionic surfactant, wherein the alkyl sulfated anionic surfactant has an average degree of alkoxylation of less than 1.0, preferably less than 0.7, more preferably less than 0.1 and is more preferably free of any alkoxylation. If alkoxylation is present, the alkyl sulfated anionic surfactant is preferably ethoxylated. the surfactant system comprises at least 40%, preferably from 50% to 90%, more preferably from 60% to 80% by weight of the surfactant system of the anionic surfactant.

The average degree of alkoxylation is the mol average degree of alkoxylation (i.e., mol average alkoxylation degree) of all the alkyl sulfated anionic surfactant. Hence, when calculating the mol average alkoxylation degree, the mols of non-alkoxylated alkyl sulfate anionic surfactant are included:

$$Mol average alkoxylation degree = ( x 1 * alkoxylation degree of surfactant 1 + x 2 * alkoxylation degree of surfactant 2 + … ) / ( x 1 + x 2 + … )$$

wherein x1, x2, . . . are the number of moles of each alkyl (or alkoxy) sulfate anionic surfactant of the mixture and alkoxylation degree is the number of alkoxy groups in each alkyl sulfated anionic surfactant.

For improved sudsing, the surfactant system comprises at least 40%, preferably from 60% to 90%, more preferably from 70% to 80% by weight of the surfactant system of the anionic surfactant.

The anionic surfactant comprises at least 50%, preferably at least 70%, more preferably at least 90% by weight of the anionic surfactant of alkyl sulfated anionic surfactant. Most preferably, the anionic surfactant consists of alkyl sulfated anionic surfactant, most preferably primary alkyl sulfated anionic surfactant. As such, while the surfactant system may comprise further anionic surfactant, including sulfonates such as HLAS, or sulfosuccinate anionic surfactants, the surfactant system can comprise no further anionic surfactant beyond the alkyl sulfated anionic surfactant.

Alternatively, the anionic surfactant can further comprise sulfonate anionic surfactant, more preferably the anionic surfactant is a mixture of the alkyl sulfated anionic surfactant the sulfonate anionic surfactant. The anionic surfactant can comprise the alkyl sulphated anionic surfactant and the sulfonated anionic surfactant in a weight ratio of from 1:1 to 8:1, preferably from 1.5:1 to 6:1, more preferably from 2:1 to 4:1. In particular, such compositions provide improved physical stability of the composition, especially at low temperatures, relative to anionic surfactant systems consisting of alkyl sulphated anionic surfactant.

Anionic sulphonate or sulphonic acid surfactants suitable for use herein include the acid and salt forms of alkylbenzene sulphonates, alkyl ester sulphonates, alkane sulphonates, alkyl sulphonated polycarboxylic acids, and mixtures thereof. Suitable anionic sulphonate or sulphonic acid surfactants include: C5-C20 alkylbenzene sulphonates, more preferably C10-C16 alkylbenzene sulphonates, more preferably C11-C13 alkylbenzene sulphonates, C5-C20 alkyl ester sulphonates, C6-C22 primary or secondary alkane sulphonates, C5-C20 sulphonated polycarboxylic acids, and any mixtures thereof, but preferably C11-C13 alkylbenzene sulphonates. The aforementioned surfactants can vary widely in their 2-phenyl isomer content.

The sulfonated anionic surfactant is preferably linear alkyl benzene sulfonate anionic surfactant. The linear alkyl benzene sulfonate anionic surfactant can have an alkyl chain comprising on average of from 10 to 16, more preferably from 10 to 14 carbon atoms, and most preferably from 10 to 13 carbon atoms. The aforementioned surfactants can vary widely in their 2-phenyl isomer content pending on their production process. Suitable production processes include the HF/n-paraffins process, DETAL process, Friedel Craft process, all starting from n-paraffins. More recently linear alkyl benzene sulphonate can also be directly derived from alfa olefins, yielding a more narrow range alkyl chain length.

The anionic surfactant can be present at a level of from 5.0% to 30%, preferably from 7.5% to 25%, more preferably from 10% to 20% by weight of the composition.

The alkyl sulfated anionic surfactant has an alkyl chain comprising an average of from 8 to 18 carbon atoms, preferably from 10 to 14 carbon atoms, more preferably from 12 to 13 carbon atoms.

The alkyl chain of the alkyl sulfated anionic surfactant preferably has a mol fraction of C12 and C13 chains of at least 50%, preferably at least 65%, more preferably at least 80%, most preferably at least 90%. Suds mileage is particularly improved, especially in the presence of greasy soils, when the C13/C12 mol ratio of the alkyl chain is at least 50/50, preferably from 60/40 to 80/20, most preferably from 60/40 to 70/30, while not compromising suds mileage in the presence of particulate soils.

The alkyl sulfated anionic surfactant has a weight average degree of branching of at least 15.0%, preferably from 20% to 60%, more preferably from 30% to 50%. As such, the alkyl sulfated anionic surfactant can comprise a mixture of linear and branched alkyl sulfated anionic surfactant.

The alkyl chains of the alkyl sulphated anionic surfactant can be derived from natural or synthetic origins. The linear chains can be natural alkyl chains which are preferably derived from coconut oil, coconut oil being more sustainably derivable while having a preferred chain length. The linear alkyl chains can be blended with a highly branched alkyl chain so that less branched alkyl chains need to be added in order to arrive at the desired degree of branching.

The overall degree of branching (as well as how the branching is achieved) affects not just the sustainability of the sourcing material, but also impacts the amount of organic solvent required to physically stabilise the liquid hand dishwashing composition. The branching of the alkyl sulfated anionic surfactant also affects the viscosity as well as the viscosity upon dilution, avoiding viscosity thickening upon dilution and ensuring that the composition is readily dispersible in the water.

The level of branching in the branched alkyl sulfate or alkyl alkoxy sulfate used in the detergent composition is calculated on a molecular basis. Commercially available non-alkoxylated alkyl sulfate anionic surfactant blends that are sold as “branched” will typically comprise a blend of linear alkyl sulfate as well as branched alkyl sulfate molecules. Commercially available alkyl alkoxy sulfate anionic surfactant blends that are sold as “branched” will typically comprise a blend of linear alkyl sulfate, branched alkyl sulfate, as well as linear alkyl alkoxy sulfate and branched alkyl alkoxy sulfate molecules. The actual calculation of the average degree of branching is done based on the starting alcohol (and alkoxylated alcohols for alkyl alkoxy sulfate blends), rather than on the final sulfated materials, as explained in the weight average degree of branching calculation below:

$$Weight average degree of branching ( \% ) =$$

$$[ ( x 1 * wt \% branched alcohol 1 in alcohol 1 +$$

$$x 2 * wt \% branched alcohol 2 in alcohol 2 + … ) / ( x 1 + x 2 + … ) ] * 100$$

wherein x1, x2, . . . are the weight in grams of each alcohol in the total alcohol mixture of the alcohols which were used as starting material before (alkoxylation and) sulphation to produce the alkyl (alkoxy) sulfate anionic surfactant. In the weight average degree of branching calculation, the weight of the alkyl alcohol used to form the alkyl sulfated anionic surfactant which is not branched is included.

The weight average degree of branching and the distribution of branching can typically be obtained from the technical data sheet for the surfactant or constituent alkyl alcohol. Alternatively, the branching can also be determined through analytical methods known in the art, including capillary gas chromatography with flame ionisation detection on medium polar capillary column, using hexane as the solvent. The weight average degree of branching and the distribution of branching is based on the starting alcohol used to produce the alkyl sulfated anionic surfactant.

The branched alkyl sulfated anionic surfactant can comprise C2-branched alkyl sulfated anionic surfactant and optionally non-C2-branched alkyl sulfated anionic surfactant. The branched alkyl sulfated anionic surfactant can comprise at least 90%, preferably at least 95%, more preferably at least 98% by weight of the branched alkyl sulfated anionic surfactant of C2-branched alkyl sulfated anionic surfactant and at most 10%, preferably at most 5%, most preferably at most 2% by weight of the branched alkyl sulfated anionic surfactant of non-C2 branched alkyl sulfate anionic surfactant.

C2-branched means the alkyl branching is a single alkyl branching on the alkyl chain of the alkyl sulfated anionic surfactant and is positioned on the C2 position, as measured counting carbon atoms from the sulfate group for non-alkoxylated alkyl sulfate anionic surfactants, or counting from the alkoxy-group furthest from the sulfate group for alkoxylated alkyl sulfate anionic surfactants.

Non-C2 branching means the alkyl chain comprises branching at multiple carbon positions along the alkyl chain backbone, or a single branching group present on a branching position on the alkyl chain other than the C2 position.

The non-C2 branched alkyl sulfated anionic surfactant can comprise less than 30%, preferably less than 20%, more preferably less than 10% by weight of the non-C2 branched alkyl sulfated anionic surfactant of C1-branched alkyl sulfated anionic surfactant, most preferably the non-C2 branched alkyl sulfated anionic surfactant is free of C1-branched alkyl sulfated anionic surfactant.

The non-C2 branched alkyl sulfated anionic surfactant can comprise at least 50%, preferably from 60 to 90%, more preferably from 70 to 80% by weight of the non-C2 branched alkyl sulfated anionic surfactant of isomers comprising a single branching at a branching position greater than the 2-position. That is, more than 2 carbons atoms away from the hydrophilic headgroup, as defined above. The non-C2 branched alkyl sulfated anionic surfactant can comprise from 5% to 30%, preferably from 7% to 20%, more preferably from 10% to 15% by weight of the non-C2 branched alkyl sulfated anionic surfactant of multi-branched isomers. The non-C2 branched alkyl sulfated anionic surfactant can comprise from 5% to 30%, preferably from 7% to 20%, more preferably from 10% to 15% by weight of non-C2 branched alkyl sulfated anionic surfactant of cyclic isomers. If present, the acyclic branching groups can be selected from C1 to C5 alkyl groups, and mixtures thereof.

It has been found that formulating the compositions using alkyl sulfated anionic surfactants having the aforementioned branching distribution and reduced to nil ethoxylation results in reduced viscosensitivity to variations in temperature and, as such, a more consistent dosage experience, compared to compositions comprising alkyl sulfated anionic surfactants with a comparative branching distribution. Moreover, the composition maintains a Newtonian viscosity profile for a broader shear rate range, which means less dosage variation and a more consistent user experience, regardless of how hard the container is squeezed.

Suitable counterions for the anionic surfactant include alkali metal cation earth alkali metal cation, alkanolammonium or ammonium or substituted ammonium, but preferably sodium.

Suitable examples of commercially available alkyl sulfated anionic surfactants include, those derived from alcohols sold under the Neodol® brand-name by Shell, or the Lial®, Isalchem®, and Safol® brand-names by Sasol, or some of the natural alcohols produced by The Procter & Gamble Chemicals company. The alcohols can be blended in order to achieve the desired average alkyl chain, average degree of branching and type of branching distribution. Considering the targeted branched alkyl sulfated anionic surfactant has a high dominance of C2 branched alkyl sulfated anionic surfactant content, preferably the alkyl sulfated anionic surfactant comprises an OXO derived alkyl sulfated anionic surfactant, such as commercially available under the lial and isalchem brandname from the Sasol company, and Neodol from the Shell company, OXO derived alkyl sulfated anionic surfactants comprising branched alkyl sulfated anionic surfactant consisting essentially of C2 branched alkyl sulfate anionic surfactant. OXO alcohols are alcohols that are prepared by adding carbon monoxide (CO) and hydrogen (usually combined together as synthesis gas) to an olefin to obtain an aldehyde using the hydroformylation reaction and then hydrogenating the aldehyde to obtain the alcohol. More preferably the alkyl sulfated anionic surfactant comprises from 60% to 85%, preferably from 75% to 85% by weight of the alkyl sulfated anionic surfactant of OXO-derived alkyl sulfated anionic surfactant, wherein OXO alcohols are alcohols that are prepared by adding carbon monoxide (CO) and hydrogen to an olefin to obtain an aldehyde using the hydroformylation reaction and then hydrogenating the aldehyde to obtain the alcohol. Alternative processes yielding alkyl sulfated anionic surfactants comprising branched alkyl sulfated anionic surfactant with high dominance of C2 branched alkyl sulfated anionic surfactant are also considered suitable. An example of such an alternative process is described in U.S. applications 63/035,125 and 63/035,131. As such the alkyl sulfated anionic surfactant then comprises at least 30%, preferably from 40% to 95%, more preferably from 50% to 85% by weight of alkyl sulfated anionic surfactant of this alternative process derived alkyl sulfated anionic surfactant, or of a mixture of OXO derived and this alternative process derived alkyl sulfated anionic surfactant.

If ethoxylated alkyl sulfate is present, without wishing to be bound by theory, through tight control of processing conditions and feedstock material compositions, both during alkoxylation especially ethoxylation and sulfation steps, the amount of 1,4-dioxane by-product within alkoxylated especially ethoxylated alkyl sulfates can be reduced. Based on recent advances in technology, a further reduction of 1,4-dioxane by-product can be achieved by subsequent stripping, distillation, evaporation, centrifugation, microwave irradiation, molecular sieving or catalytic or enzymatic degradation steps. Processes to control 1,4-dioxane content within alkoxylated/ethoxylated alkyl sulfates have been described extensively in the art. Alternatively 1,4-dioxane level control within detergent formulations has also been described in the art through addition of 1,4-dioxane inhibitors to 1,4-dioxane comprising formulations, such as 5,6-dihydro-3-(4-morpholinyl)-1-[4-(2-oxo-1-piperidinyl)-phenyl]-2-(1-H)-pyridone, 3-α-hydroxy-7-oxo stereoisomer-mixtures of cholinic acid, 3-(N-methyl amino)-L-alanine, and mixtures thereof.

### Alkyl Polyglucoside Surfactant

The surfactant system comprises an alkyl polyglucoside nonionic surfactant. Alkyl polyglucoside nonionic surfactant has been found to further improve the antimicrobial efficacy of the compositions of the present disclosure. As such, the alkyl polyglucoside nonionic surfactant can be present at a level of from 0.1% to 10%, preferably from 1.0% to 8.0%, more preferably from 3.0% to 6.5% by weight of the composition.

Alkyl polyglucoside nonionic surfactants are typically more sudsing than other nonionic surfactants such as alkyl ethoxlated alcohols, especially in the presence of particulate soils.

A combination of alkylpolyglucoside and alkyl sulfated anionic surfactant has also been found to improve polymerized grease removal, suds mileage performance, reduced viscosity variation with changes in the surfactant and/or the surfactant system, and a more sustained Newtonian rheology across a wider surfactant active level range.

The alkyl polyglucoside surfactant can have an alkyl chain comprising an average length of from 8 to 18 carbon atoms, preferably from 10 to 16 carbon atoms, more preferably from 12 to 14 carbon atoms. The alkyl polyglucoside surfactant can alternatively comprise a blend of short chain alkyl polyglucoside surfactant having an alkyl chain comprising 10 carbon atoms or less, and mid to long chain alkyl polyglucoside surfactant having an alkyl chain comprising greater than 10 carbon atoms to 18 carbon atoms, preferably from 12 to 14 carbon atoms.

The alkyl polyglucoside surfactant can have a number average degree of polymerization of from 0.1 to 3.0, preferably from 1.0 to 2.0, more preferably from 1.2 to 1.6.

Short chain alkyl polyglucoside surfactants have a monomodal chain length distribution between C8-C10, mid to long chain alkyl polyglucoside surfactants have a monomodal chain length distribution between C10-C18, while mid chain alkyl polyglucoside surfactants have a monomodal chain length distribution between C12-C14. In contrast, C8 to C18 alkyl polyglucoside surfactants typically have a monomodal distribution of alkyl chains between C8 and C18, as with C8 to C₁₆ and the like. As such, a combination of short chain alkyl polyglucoside surfactants with mid to long chain or mid chain alkyl polyglucoside surfactants have a broader distribution of chain lengths, or even a bimodal distribution, than non-blended C8 to C18 alkyl polyglucoside surfactants. Preferably, the weight ratio of short chain alkyl polyglucoside surfactant to long chain alkyl polyglucoside surfactant is from 1:1 to 10:1, preferably from 1.5:1 to 5:1, more preferably from 2:1 to 4:1. It has been found that a blend of such short chain alkyl polyglucoside surfactant and long chain alkyl polyglucoside surfactant results in faster dissolution of the detergent solution in water and improved initial sudsing, in combination with improved suds stability.

The anionic surfactant and alkyl polyglucoside surfactant can be present at a weight ratio of from greater than 1:1 to 10:1, preferably from 1.5:1 to 5:1, more preferably from 2:1 to 4:1

C8-C16 alkyl polyglucosides are commercially available from several suppliers (e.g., Simusol® surfactants from Seppic Corporation; and Glucopon® 600 CSUP, Glucopon® 650 EC, Glucopon® 600 CSUP/MB, and Glucopon® 650 EC/MB, from BASF Corporation). Glucopon® 215UP is a preferred short chain APG surfactant. Glucopon® 600CSUP is a preferred mid to long chain APG surfactant.

### Co-Surfactant

In order to improve surfactant packing after dilution and hence improve suds mileage, the surfactant system can comprise a co-surfactant in addition to the anionic surfactant.

The co-surfactant can be selected from the group consisting of an amphoteric surfactant, a zwitterionic surfactant, and mixtures thereof.

The weight ratio of anionic surfactant to the co-surfactant can be from 2.0:1 to 8.0:1, preferably from 2.0:1 to 5.0:1, more preferably from 2.5:1 to 4.0:1, in order to provide improved grease cleaning, sudsing and viscosity build.

The surfactant system can comprise from 0.1% to 20%, preferably from 0.5% to 15%, more preferably from 2% to 10% by weight of the cleaning composition of the co-surfactant. The surfactant system of the cleaning composition of the present disclosure can comprise from 10% to 40%, preferably from 15% to 35%, more preferably from 20% to 30%, by weight of the surfactant system of the co-surfactant.

The co-surfactant can be an amphoteric surfactant, such as an amine oxide surfactant. The amine oxide surfactant can be linear or branched, though linear are preferred. Suitable linear amine oxides are typically water-soluble, and characterized by the formula R1-N(R2) (R3)O wherein R1 is a C8-18 alkyl, and the R2 and R3 moieties are selected from the group consisting of C1-3 alkyl groups, C1-3 hydroxyalkyl groups, and mixtures thereof. For instance, R2 and R3 can be selected from the group consisting of: methyl, ethyl, propyl, isopropyl, 2-hydroxethyl, 2-hydroxypropyl and 3-hydroxypropyl, and mixtures thereof, though methyl is preferred for one or both of R2 and R3. The linear amine oxide surfactants in particular may include linear C10-C18 alkyl dimethyl amine oxides and linear C8-C12 alkoxy ethyl dihydroxy ethyl amine oxides.

Preferably, the amine oxide surfactant is selected from the group consisting of: alkyl dimethyl amine oxide, alkyl amido propyl dimethyl amine oxide, and mixtures thereof. Alkyl dimethyl amine oxides are preferred, such as C8-18 alkyl dimethyl amine oxides, or C10-16 alkyl dimethyl amine oxides (such as coco dimethyl amine oxide). Suitable alkyl dimethyl amine oxides include C10 alkyl dimethyl amine oxide surfactant, C10-12 alkyl dimethyl amine oxide surfactant, C12-C14 alkyl dimethyl amine oxide surfactant, and mixtures thereof. C12-C14 alkyl dimethyl amine oxide are particularly preferred. Preferably, the alkyl chain of the alkyl dimethyl amine oxide is a linear alkyl chain, preferably a C12-C14 alkyl chain, more preferably a C12-C14 alkyl chain derived from coconut oil or palm kernel oil.

Alternative suitable amine oxide surfactants include mid-branched amine oxide surfactants. As used herein, “mid-branched” means that the amine oxide has one alkyl moiety having n1 carbon atoms with one alkyl branch on the alkyl moiety having n2 carbon atoms. The alkyl branch is located on the a carbon from the nitrogen on the alkyl moiety. This type of branching for the amine oxide is also known in the art as an internal amine oxide. The total sum of n1 and n2 can be from 10 to 24 carbon atoms, preferably from 12 to 20, and more preferably from 10 to 16. The number of carbon atoms for the one alkyl moiety (n1) is preferably the same or similar to the number of carbon atoms as the one alkyl branch (n2) such that the one alkyl moiety and the one alkyl branch are symmetric. As used herein “symmetric” means that | n1−n2| is less than or equal to 5, preferably 4, most preferably from 0 to 4 carbon atoms in at least 50 wt %, more preferably at least 75 wt % to 100 wt % of the mid-branched amine oxides for use herein. The amine oxide further comprises two moieties, independently selected from a C1-3 alkyl, a C1-3 hydroxyalkyl group, or a polyethylene oxide group containing an average of from 1 to 3 ethylene oxide groups. Preferably, the two moieties are selected from a C1-3 alkyl, more preferably both are selected as C1 alkyl.

Alternatively, the amine oxide surfactant can be a mixture of amine oxides comprising a mixture of low-cut amine oxide and mid-cut amine oxide. The amine oxide of the composition can then comprises:
a) from 10% to 45% by weight of the amine oxide of low-cut amine oxide of formula RIR2R3AO wherein R1 and R2 are independently selected from hydrogen, C1-C4 alkyls or mixtures thereof, and R3 is selected from C10 alkyls and mixtures thereof; and
b) from 55% to 90% by weight of the amine oxide of mid-cut amine oxide of formula R4R5R6AO wherein R4 and R5 are independently selected from hydrogen, C1-C4 alkyls or mixtures thereof, and R6 is selected from C12-C16 alkyls or mixtures thereof

In a preferred low-cut amine oxide for use herein R³ is n-decyl, with preferably both R1 and R2 being methyl. In the mid-cut amine oxide of formula R4R5R6AO, R4 and R5 are preferably both methyl.

Preferably, the amine oxide comprises less than 5%, more preferably less than 3%, by weight of the amine oxide of an amine oxide of formula R7R8R9AO wherein R7 and R8 are selected from hydrogen, C1-C4 alkyls and mixtures thereof and wherein R9 is selected from C8 alkyls and mixtures thereof. Limiting the amount of amine oxides of formula R7R8R9AO improves both physical stability and suds mileage.

The co-surfactant can be one or more zwitterionic surfactant such as a betaine surfactant. Such betaine surfactants include alkyl betaines, alkylamidobetaine, amidazoliniumbetaine, sulphobetaine (INCI Sultaines) as well as the Phosphobetaine, and preferably meets formula (I):

R¹—[CO—X(CH₂)ₙ]ₓ—N⁺(R²)(R₃)—(CH₂)ₘ—[CH(OH)—CH₂]_{y}-Y⁻
wherein in formula (I),
R1 is selected from the group consisting of: a saturated or unsaturated C6-22 alkyl residue, preferably C8-18 alkyl residue, more preferably a saturated C10-16 alkyl residue, most preferably a saturated C12-14 alkyl residue;
X is selected from the group consisting of: NH, NR4 wherein R4 is a C1-4 alkyl residue, O, and S,
n is an integer from 1 to 10, preferably 2 to 5, more preferably 3,
x is 0 or 1, preferably 1,
R2 and R3 are independently selected from the group consisting of: a C1-4 alkyl residue, hydroxy substituted such as a hydroxyethyl, and mixtures thereof, preferably both R2 and R3 are methyl,
m is an integer from 1 to 4, preferably 1, 2 or 3,
y is 0 or 1, and
Y is selected from the group consisting of: COO, SO3, OPO(OR5)O or P(O)(OR5)O, wherein R5 is H or a C1-4 alkyl residue.

Preferred betaines are the alkyl betaines of formula (IIa), the alkyl amido propyl betaine of formula (IIb), the sulphobetaines of formula (IIc) and the amido sulphobetaine of formula (IId):

R¹—N⁺(CH₃)₂—CH₂COO⁻ (IIa)

R¹—CO—NH—(CH₂)₃—N⁺(CH₃)₂—CH₂COO⁻ (IIb)

R¹—N⁺(CH₃)₂—CH₂CH(OH)CH₂SO₃⁻ (IIc)

R¹—CO—NH—(CH₂)₃—N⁺(CH₃)₂—CH₂CH(OH)CH₂SO₃⁻ (IId)
in which R1 has the same meaning as in formula (I). Particularly preferred are the carbobetaines [i.e. wherein Y⁻═COO— in formula (I)] of formulae (IIa) and (IIb), more preferred are the alkylamidobetaine of formula (IIb).

Suitable betaines can be selected from the group consisting or [designated in accordance with INCI]: capryl/capramidopropyl betaine, cetyl betaine, cetyl amidopropyl betaine, cocamidoethyl betaine, cocamidopropyl betaine, cocobetaines, decyl betaine, decyl amidopropyl betaine, hydrogenated tallow betaine/amidopropyl betaine, isostearamidopropyl betaine, lauramidopropyl betaine, lauryl betaine, myristyl amidopropyl betaine, myristyl betaine, oleamidopropyl betaine, oleyl betaine, palmamidopropyl betaine, palmitamidopropyl betaine, palm-kernelamidopropyl betaine, stearamidopropyl betaine, stearyl betaine, tallowamidopropyl betaine, tallow betaine, undecylenamidopropyl betaine, undecyl betaine, and mixtures thereof. Preferred betaines are selected from the group consisting of: cocamidopropyl betaine, cocobetaines, lauramidopropyl betaine, lauryl betaine, myristyl amidopropyl betaine, myristyl betaine, and mixtures thereof. Cocamidopropyl betaine is particularly preferred.

Preferably the co-surfactant is a zwitterionic surfactant, more preferably a betaine surfactant, most preferably cocoamidopropylbetaine.

### Further Nonionic Surfactant

The composition can comprise a further nonionic surfactant. The further nonionic surfactant is preferably selected from the group consisting of alkoxylated alkyl alcohol, and mixtures thereof.

The surfactant system can comprise the further nonionic surfactant at a level of from 1% to 25%, preferably from 1.25% to 15%, more preferably from 3.0% to 8.0%, by weight of the surfactant system.

Suitable alkoxylated non-ionic surfactants can be linear or branched, primary or secondary alkyl alkoxylated non-ionic surfactants. The alkoxylated nonionic surfactant can comprise on average of from 8 to 18, preferably from 9 to 15, more preferably from 10 to 14 carbon atoms in its alkyl chain.

Alkyl ethoxylated non-ionic surfactant are preferred. Suitable alkyl ethoxylated non-ionic surfactants can comprise an average of from 5 to 12, preferably from 6 to 10, more preferably from 7 to 8, units of ethylene oxide per mole of alcohol. Such alkyl ethoxylated nonionic surfactants can be derived from synthetic alcohols, such as OXO-alcohols and Fisher Tropsh alcohols, or from naturally derived alcohols, or from mixtures thereof. Suitable examples of commercially available alkyl ethoxylate nonionic surfactants include, those derived from synthetic alcohols sold under the Neodol® brand-name by Shell, or the Lial®, Isalchem®, and Safol® brand-names by Sasol, or some of the natural alcohols produced by The Procter & Gamble Chemicals company.

Carboxylic Acid and/or Salt Thereof:

The carboxylic acid and/or a salt thereof comprises lactic acid and/or a salt thereof. The lactic acid and/or a salt thereof can be present at a level from 0.1% to 10%, preferably from 0.5% to 5.0%, more preferably from 1.0% to 3.0% by weight of the composition.

The composition may comprise further carboxylic acids or salts thereof, such as those selected from the group consisting of citric acid, oxalic acid, sorbic acid, acetic acid, tartaric acid, formic acid, maleic acid, adipic acid, malic acid, malonic acid, glycolic acid, propanoic acid, propionic acid, salicylic acid, benzoic acid, orthohydroxy benzoic acid, salts thereof, and mixtures thereof. Preferred further carboxylic acid or a salt thereof can be selected from the group consisting of citric acid, acetic acid, salts thereof, and mixtures thereof, even more preferably the further carboxylic acid or a salt thereof is selected from the group consisting of citric acid, acetic acid, salts thereof, and mixtures thereof. The further carboxylic acid can be present at a level of from 0.1% to 10%, preferably from 0.5% to 5.0%, more preferably from 1.0% to 3.0% by weight of the composition.

### Further Ingredients:

The composition can comprise further ingredients such as those selected from: amphiphilic alkoxylated polyalkylencimines, cyclic polyamines, triblock copolymers, salts, hydrotropes, organic solvents, other adjunct ingredients such as those described herein, and mixtures thereof.

### Amphiphilic Alkoxylated Polyalkyleneimine:

The composition of the present disclosure may further comprise from 0.05% to 2%, preferably from 0.07% to 1% by weight of the total composition of an amphiphilic polymer. Suitable amphiphilic polymers can be selected from the group consisting of: amphiphilic alkoxylated polyalkyleneimine and mixtures thereof. The amphiphilic alkoxylated polyalkyleneimine polymer has been found to reduce gel formation on the hard surfaces to be cleaned when the liquid composition is added directly to a cleaning implement (such as a sponge) before cleaning and consequently brought in contact with heavily greased surfaces, especially when the cleaning implement comprises a low amount to nil water such as when light pre-wetted sponges are used.

A preferred amphiphilic alkoxylated polyethyleneimine polymer has the general structure of formula (I):

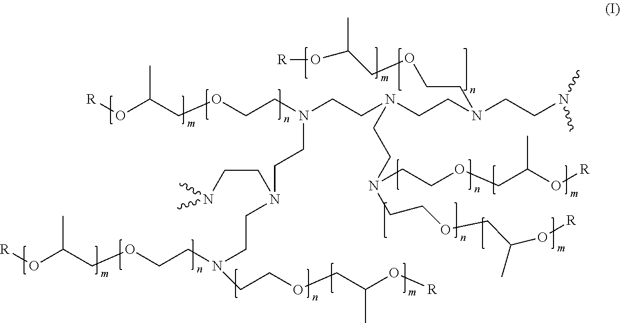

wherein the polyethyleneimine backbone has a weight average molecular weight of 600, n of formula (I) has an average of 10, m of formula (I) has an average of 7 and R of formula (I) is selected from hydrogen, a C₁-C₄ alkyl and mixtures thereof, preferably hydrogen. The degree of permanent quaternization of formula (I) may be from 0% to 22% of the polyethyleneimine backbone nitrogen atoms. The molecular weight of this amphiphilic alkoxylated polyethyleneimine polymer preferably is between 10,000 and 15,000 Da.

More preferably, the amphiphilic alkoxylated polyethyleneimine polymer has the general structure of formula (I) but wherein the polyethyleneimine backbone has a weight average molecular weight of 600 Da, n of Formula (I) has an average of 24, m of Formula (I) has an average of 16 and R of Formula (I) is selected from hydrogen, a C₁-C₄ alkyl and mixtures thereof, preferably hydrogen. The degree of permanent quaternization of Formula (I) may be from 0% to 22% of the polyethyleneimine backbone nitrogen atoms and is preferably 0%. The molecular weight of this amphiphilic alkoxylated polyethyleneimine polymer preferably is between 25,000 and 30,000, most preferably 28,000 Da.

The amphiphilic alkoxylated polyethyleneimine polymers can be made by the methods described in more detail in PCT Publication No. WO 2007/135645.

### Cyclic Polyamine

The composition can comprise a cyclic polyamine having amine functionalities that helps cleaning. The composition preferably comprises from 0.1% to 3%, more preferably from 0.2% to 2%, and especially from 0.5% to 1%, by weight of the composition, of the cyclic polyamine.

The cyclic polyamine has at least two primary amine functionalities. The primary amines can be in any position in the cyclic amine but it has been found that in terms of grease cleaning, better performance is obtained when the primary amines are in positions 1,3. It has also been found that cyclic amines in which one of the substituents is —CH3 and the rest are H provided for improved grease cleaning performance.

Accordingly, the most preferred cyclic polyamine for use with the cleaning composition of the present disclosure are cyclic polyamine selected from the group consisting of: 2-methylcyclohexane-1,3-diamine, 4-methylcyclohexane-1,3-diamine and mixtures thereof. These specific cyclic polyamines work to improve suds and grease cleaning profile through-out the dishwashing process when formulated together with the surfactant system of the composition of the present disclosure.

Suitable cyclic polyamines can be supplied by BASF, under the Baxxodur tradename, with Baxxodur ECX-210 being particularly preferred.

A combination of the cyclic polyamine and magnesium sulphate is particularly preferred. As such, the composition can further comprise magnesium sulphate at a level of from 0.001% to 2.0%, preferably from 0.005% to 1.0%, more preferably from 0.01% to 0.5% by weight of the composition.

### Triblock Co-Polymer

The composition can comprise a triblock copolymer. The triblock co-polymers can be present at a level of from 0.1% to 10%, preferably from 0.5% to 7.5%, more preferably from 1% to 5%, by weight of the total composition. Suitable triblock copolymers include alkylene oxide triblock co-polymers, defined as a triblock co-polymer having alkylene oxide moieties according to Formula (I): (EO)x(PO)y(EO)x, wherein EO represents ethylene oxide, and each x represents the number of EO units within the EO block. Each x can independently be on average of from 5 to 50, preferably from 10 to 40, more preferably from 10 to 30. Preferably x is the same for both EO blocks, wherein the “same” means that the x between the two EO blocks varies within a maximum 2 units, preferably within a maximum of 1 unit, more preferably both x's are the same number of units. PO represents propylene oxide, and y represents the number of PO units in the PO block. Each y can on average be from between 10 to 60, preferably from 15 to 55, more preferably from 20 to 48.

Preferably the triblock co-polymer has a ratio of y to each x of from 3:1 to 1.5:1. The triblock co-polymer preferably has a ratio of y to the average x of 2 EO blocks of from 3:1 to 1.5:1. Preferably the triblock co-polymer has an average weight percentage of total EO of between 30% and 50% by weight of the tri-block co-polymer. Preferably the triblock co-polymer has an average weight percentage of total PO of between 50% and 70% by weight of the triblock co-polymer. It is understood that the average total weight % of EO and PO for the triblock co-polymer adds up to 100%. The triblock co-polymer can have an average molecular weight of between 1500 and 7880, preferably between 1750 and 6710, more preferably between 2000 and 5430, most preferably between 2100 and 4700. Average molecular weight is determined using a 1H NMR spectroscopy (see Thermo scientific application note No. AN52907).

Triblock co-polymers have the basic structure ABA, wherein A and B are different homopolymeric and/or monomeric units. In this case A is ethylene oxide (EO) and B is propylene oxide (PO). Those skilled in the art will recognize the phrase “block copolymers” is synonymous with this definition of “block polymers”.

Triblock co-polymers according to Formula (I) with the specific EO/PO/EO arrangement and respective homopolymeric lengths have been found to enhances suds mileage performance of the liquid hand dishwashing detergent composition in the presence of greasy soils and/or suds consistency throughout dilution in the wash process.

Suitable EO-PO-EO triblock co-polymers are commercially available from BASF such as Pluronic® PE series, and from the Dow Chemical Company such as Tergitol™ L series. Particularly preferred triblock co-polymer from BASF are sold under the tradenames Pluronic® L44 (MW ca 2200, ca 44 wt % EO), Pluronic® PE6400 (MW ca 2900, ca 40 wt % EO) and Pluronic® PE 9400 (MW ca 4600, 40 wt % EO). Particularly preferred triblock co-polymer from the Dow Chemical Company is sold under the tradename Tergitol™ L64 (MW ca 2700, ca 40 wt % EO).

Preferred triblock co-polymers are readily biodegradable under aerobic conditions.

The composition of the present disclosure may further comprise at least one active selected from the group consisting of: salt, hydrotrope, organic solvent, and mixtures thereof.

### Salt:

The composition of the present disclosure may comprise from 0.05% to 2%, preferably from 0.1% to 1.5%, or more preferably from 0.5% to 1%, by weight of the total composition of a salt, preferably a monovalent or divalent inorganic salt, or a mixture thereof, more preferably selected from: sodium chloride, sodium sulfate, and mixtures thereof. Sodium chloride is most preferred.

### Hydrotrope:

The composition of the present disclosure may comprise from 0.1% to 10%, or preferably from 0.5% to 10%, or more preferably from 1% to 10% by weight of the total composition of a hydrotrope or a mixture thereof, preferably sodium cumene sulfonate.

### Organic Solvent:

The composition can comprise from 0.1% to 10%, or preferably from 0.5% to 10%, or more preferably from 1% to 10% by weight of the total composition of an organic solvent. Suitable organic solvents include organic solvents selected from the group consisting of: alcohols, glycols, glycol ethers, and mixtures thereof, preferably alcohols, glycols, and mixtures thereof. Ethanol is the preferred alcohol. Polyalkyleneglycols, especially polypropyleneglycol (PPG), are the preferred glycol. The polypropyleneglycol can have a molecular weight of from 400 to 3000, preferably from 600 to 1500, more preferably from 700 to 1300. The polypropyleneglycol is preferably poly-1,2-propyleneglycol.

### Adjunct Ingredients

The cleaning composition may optionally comprise a number of other adjunct ingredients such as builders, chelants, conditioning polymers, other cleaning polymers, surface modifying polymers, structurants, emollients, humectants, skin rejuvenating actives, enzymes, scrubbing particles, perfumes, malodor control agents, pigments, dyes, opacifiers, pearlescent particles, inorganic cations such as alkaline earth metals such as Ca/Mg-ions, antibacterial agents, preservatives, viscosity adjusters (e.g., salt such as NaCl, and other mono-, di- and trivalent salts) and pH adjusters and buffering means (e.g. carboxylic acids such as citric acid, HCl, NaOH, KOH, alkanolamines, and alike).

### Packaged Product

The hand dishwashing detergent composition can be packaged in a container, typically plastic containers. Suitable containers comprise an orifice. Typically, the container comprises a cap, with the orifice typically comprised on the cap. The cap can comprise a spout, with the orifice at the exit of the spout. The spout can have a length of from 0.5 mm to 10 mm.

The orifice can have an open cross-sectional surface area at the exit of from 3 mm² to 20 mm², preferably from 3.8 mm² to 12 mm², more preferably from 5 mm² to 10 mm², wherein the container further comprises the composition. The cross-sectional surface area is measured perpendicular to the liquid exit from the container (that is, perpendicular to the liquid flow during dispensing).

The container can typically comprise from 200 ml to 5,000 ml, preferably from 350 ml to 2000 ml, more preferably from 400 ml to 1,000 ml of the household cleaning composition.

The hand dishwashing detergent composition can be packaged in a container, typically plastic containers. Suitable containers comprise an orifice. Typically, the container comprises a cap, with the orifice typically comprised on the cap. The cap can comprise a spout, with the orifice at the exit of the spout. The spout can have a length of from 0.5 mm to 10 mm.

Alternatively, the hand dishwashing detergent composition can be packaged in an inverted container. Such inverted containers typically comprise a cap at the bottom of the container, the cap comprising either a closure or a self-sealing valve, or a combination thereof. The cap preferably comprises a self-sealing valve. Suitable self-sealing valves include slit-valves. The self-scaling valve defines a dispensing orifice that is reactively openable when the pressure on the valve interior side exceeds the pressure on the valve exterior side. The bottom dispensing container can comprise an impact resistance system, such as that described in WO2019108293A1.

The hand dishwashing detergent composition can be packaged in a spray dispenser. In order to be suitable for spray application, suitable hand dishwashing compositions typically have a viscosity of less than 100 mPa·s, preferably from 1.0 mPa·s to 50 mPa·s, more preferably from 1.0 mPa·s to 20 mPa·s, measured using a rheometer, such as a “TA instruments DHR1” rheometer, using a cone and plate geometry with a flat steel Peltier plate and a 60 mm diameter, 2.026° cone (TA instruments, serial number: SN960912), or similar.

Spray dispensers comprise a reservoir to accommodate the composition and spraying means. Suitable spray dispensers include hand pump (sometimes referred to as “trigger”) devices, pressurized can devices, electrostatic spray devices, etc. Preferably the spray dispenser is non-pressurized and the spray means are of the trigger dispensing type. The reservoir is typically a container such as a bottle, more typically a plastic bottle.

The spray dispenser typically comprises a trigger lever which, once depressed, activates a small pump. The main moving element of the pump is typically a piston, housed inside a cylinder, with the piston pressing against a spring. By depressing the trigger, the piston is pushed into the cylinder and against the spring, compressing the spring, and forcing the composition contained within the pump out of a nozzle. Once the trigger lever is released, the spring pushes the piston back out, expanding the cylinder area, and sucking the composition from the reservoir, typically through a one-way valve, and refilling the pump. This pump is typically attached to a tube that draws the composition from the reservoir into the pump. The spray dispenser can comprise a further one-way valve, situated between the pump and the nozzle.

The nozzle comprises an orifice through which the composition is dispensed. The nozzle utilises the kinetic energy of the composition to break it up into droplets as it passes through the orifice. Suitable nozzles can be plain, or shaped, or comprise a swirl chamber immediately before the orifice. Such swirl chambers induce a rotary fluid motion to the composition which causes swirling of the composition in the swirl chamber. A film is discharged from the perimeter of the orifice which typically results in dispensing the composition from the orifice as finer droplets.

Since such trigger-activated spray dispensers comprise a pump, the composition preferably is not pressurized within the reservoir and preferably does not comprise a propellant.

The spray dispenser can be a pre-compression sprayer which comprises a pressurized buffer for the composition, and a pressure-activated one-way valve between the buffer and the spray nozzle. Such precompression sprayers provide a more uniform spray distribution and more uniform spray droplet size since the composition is sprayed at a more uniform pressure. Such pre-compression sprayers include the Flairosol® spray dispenser, manufactured and sold by Afa Dispensing Group (The Netherlands) and the pre-compression trigger sprayers described in U.S. Patent Publication Nos. 2013/0112766 and 2012/0048959.

### Method of Washing

The compositions of use in the present disclosure are used in methods of manually washing dishware. The method comprises the step of: contacting dishware with the liquid hand dishwashing detergent composition of the present disclosure.

The water present in usual households can typically have a hardness of up to 3.0 mmol/l CaCO₃ equivalence. As such, the method described herein is suitable for use when washing with water having a hardness of up to 3.0 mmol/l, preferably 0.3 mmol/l to 2.7 mmol/l, more preferably from 0.75 mmol/l to 2 mmol/l CaCO₃ equivalence.

Suitable methods can include the steps of delivering a liquid hand dishwashing composition to a volume of water to form a wash solution and immersing the dishware in the wash solution. The dishware is cleaned with the composition in the presence of water.

The wash solution can comprise the liquid hand dishwashing detergent composition at a level of from 100 ppm to 10,000 ppm, preferably from 200 ppm to 5000 ppm, more preferably from 500 ppm to 2000 ppm.

Typically, from 0.5 ml to 50 ml, preferably from 1.0 ml to 25 ml, more preferably from 2.5 ml to 10 ml of the liquid hand dishwashing detergent composition is combined with 1.0 l to 15 l, preferably from 1.5 l to 10 l, more preferably from 2.5 to 7.5 l of water to form the wash solution. The actual amount of detergent composition used will be based on the judgment of the user, and will typically depend upon factors such as the particular product formulation of the detergent composition, including the concentration of active ingredients in the detergent composition, the number of soiled dishes to be cleaned, the degree of soiling on the dishes, and the like.

The soiled dishware is immersed in the wash liquor obtained, before scrubbing the soiled surface of the dishware with a cloth, sponge, or similar cleaning implement. The cloth, sponge, or similar cleaning implement is typically contacted with the dishware for a period of time ranged from 1 to 10 seconds, although the actual time will vary with each application and user preferences. Scrubbing can sometimes also take place after a period of soaking, for instance, after about 30 minutes of soaking.

Alternatively, prior to contacting the dishware with the liquid hand dishwashing detergent composition and the water, the liquid hand dishwashing detergent composition and the water are combined on a device, preferably wherein the device is a brush, a sponge, a nonwoven material, or a woven material, more preferably wherein the device is a sponge. The liquid hand dishwashing detergent composition and water can be combined on or in the device at ratios of from 25:75 to 1:99, preferably 15:85 to 1:99, more preferably 10:90 to 1:99.

The cleaning device or implement, and consequently the liquid dishwashing composition and the water, is directly contacted to the surface of each of the soiled dishes, to remove the soiling. The cleaning device or implement is typically contacted with each dishware surface for a period of time range from 1 to 10 seconds, although the actual time of application will depend upon factors such as the degree of soiling of the dish. The contacting of said cleaning device or implement to the dish surface is preferably accompanied by concurrent scrubbing

The dishware can be subsequently rinsed. By “rinsing”, it is meant herein contacting the dishware cleaned with the process according to the present disclosure with substantial quantities of water. By “substantial quantities”, it is meant usually from 1.0 to 20 L, or under running water.

### Test Methods

pH

The pH is measured as a 10% solution in demineralized water at 20° C., unless specified otherwise.

### Microbial Susceptibility:

The following Microbial Susceptibility Test (MST) method is used to assess the preservative efficacy of a liquid cleaning composition.

The following lab equipment is used for the test:
Petri dishes, automatic pipettors, serological pipettes, 25 ml disposable syringe/pipette, autoclavable containers, sample containers with tight fitting lids, swabs, all sterilised
UV-Vis spectrophotometer (such as Mettler Toledo Cuvette Spectrophotometer)
Autoclave (such as Phoenix 40 Autoclave, supplied by Rodwell)
Incubators (supplied by Bioscience)
Balance (0-200 g range, at least 0.5 g accuracy, such as supplied by Mettler Toledo)

The following test media are used:
Modified letheen broth with polysorbate 80 and lecithin (MLBTL, supplied by BioMérieux FR under order code 44539)
Modified letheen Agar with polysorbate 80 (MLAT, supplied by BioMérieux FR under order code 257607, MLAT will be cloudy and may be swirled immediately on removal from the autoclave prior to being cooled to re-suspend the polysorbate 80)
Physiological saline 0.85% (NaCl 0.85%)
Tryptic soy agar plates (TSA plates, supplied by BioMérieux FR)
Sabouraud dextrose agar plates (SDA plates, supplied by BioMérieux FR)

The test inoculum preparations are prepared as follows. The preparations are used the day that they are prepared. The test organisms used are summarized in Table 1 below.

### Bacteria Inoculum Preparation:

Streak the surface of a TSA plate for each bacterial challenge organism. Incubate at 30° C. to 35° C. for 18 to 24 hours in the incubator. After incubation, collect growth by gently rolling a dry sterile swab across confluent growth. Transfer the growth on the swab into a container of sterile saline (0.85% NaCl) to generate a turbid solution of cells. Thoroughly homogenise the resultant suspension to obtain an even dispersion. Measure the inoculum count. Adjust the bacterial challenge organism level or saline level to deliver a target inoculum count of between 5.0-7.0 log¹⁰ cfu/ml. The % transmission at a wavelength of 425 nm (as measured using a uv-vis spectrophotometer) as shown in Table 1 should generate an inoculum count approximately in this range.

TABLE 1
% transmittance range at 425 nm for the challenge organisms

| | | Designation at | | % |
|---|---|---|---|---|
| | | Microbiologics | ATCC | transmittance |
| | Organism | Inc. | number | (425 nm) |
| Pooled | Staphylococcus | 485 | 6538 | 23-25 |
| Inoculum | aureus | | | |
| | Pseudomonas | 484 | 9027 | 31-33 |
| | aeruginosa | | | |
| | Escherichia coli | 483 | 8739 | 31-33 |
| | Candida | 443 | 10231 | 0.2-0.4 |
| | albicans | | | |
| | Burkholderia | 488 | 25416 | 25-30 |
| | cepacia | | | |
| | Klebsiella | 556 | — | 31-33 |
| | pneumoniae | | | |
| | Enterobacter | 565 | — | 31-33 |
| | gergoviae | | | |
| | Serratia | 562 | — | 31-33 |
| | marcescens | | | |

### Yeast Inoculum Preparation:

Streak the surface of an SDA plate with the C.albicans organism. Incubate at 20° C. to 25° C. for between 44 and 52 hours. Collect the growth and adjust according to steps explained for bacteria above.

Pooled inoculum preparation and log count of the fresh pooled inoculum:

To create the pooled inoculum, mix equal parts of each of the bacteria and the yeast dispersions, as prepared above. Quantify the adjusted test inoculum preparations by preparing 10⁻⁵, 10⁻⁶, and 10⁻⁷ dilutions (the dilution factor) using MLBTL. Pour or spread 0.5 mL aliquots of each dilution on to two plates using MLAT as plating medium. Evenly distribute the inoculum and allow the agar to sufficiently harden or dry before inverting. Incubate all inoculum plates at 30 to 35° C. for 3 to 5 days.

Count the total number of colonies on both plates for each dilution. Select the set of two plates having between 50 to 250 colonies. Multiply the colony count of the selected plates by the relevant dilution factor. This is then multiplied by 0.01 to calculate the concentration of pooled inoculum in the product (in cfu/ml). This is the log count of the fresh pooled inoculum.

The inoculated liquid cleaning compositions are prepared and sampled as follows:

Aseptically weigh out 25±0.5 g of the liquid cleaning composition to be tested into a sterile container. Inoculate the liquid cleaning composition with 0.25 mL of the earlier prepared pooled inoculum and mix thoroughly, such as by turning upside down repeatedly for 10 seconds or by using a homogenizer, while avoiding excessive bubble entrainment. The actual weights of liquid cleaning composition and inoculum can vary so long as the ratio of the inoculum to liquid cleaning composition remains at 1.0% by weight.

The inoculated samples are then stored at 20 to 25° C. in the incubator for 5 mins.

### Preparation of Diluted Sample:

25±0.5 g of the liquid cleaning composition is aseptically weighed out into a sterile container for testing. Equal amounts of deionized water is added to make a 50% dilution. From this, 25 ml of diluted product is taken and placed into a sterile container.

Inoculate the liquid cleaning composition with 0.25 mL of the earlier prepared pooled inoculum and mix thoroughly, such as by turning upside down repeatedly for 10 seconds or by using a homogenizer, while avoiding excessive bubble entrainment. The actual weights of liquid cleaning composition and inoculum can vary so long as the ratio of the inoculum to liquid cleaning composition remains at 1.0% by weight.

The inoculated samples are then stored at 20 to 25° C. in the incubator for 5 mins.

The activity of the liquid cleaning composition on the pooled inoculum is stopped using the following procedure:

The samples are removed from the incubator and diluted in a 1:10 volume ratio of the sample into MLBTL (i.e. 1 mL of sample into 9 mL of MLBTL). Thoroughly mix the samples by any suitable means, such as described earlier. The sample is then further diluted in a volume ratio of 1:100 in MLBTL, to result in a 1:1000 volume ratio of the original inoculated liquid cleaning composition into MLBTL.

### Remaining Log Count of the Pooled Inoculum:

Plate a 0.5 mL aliquot of the dilutions into prepared agar plates comprising 15 to 25 mL of MLAT. Evenly distribute the aliquot and allow the agar to sufficiently harden or dry before inverting. Incubate the inverted bacterial/yeast plates at 30° C. to 35° C. for 3 days.

Following the incubation, count the colonies on the plate and multiply by 2 and then multiply by the appropriate dilution factor to calculate the remaining concentration of pooled inoculum (cfu/ml). This is the remaining log count of the pooled inoculum after ageing in the finished product for 7 days.

### Calculation of the Log Count Reduction:

The log count reduction is calculated by subtracting the remaining log count of the pooled inoculum after ageing in the finished product for 5 mins as described earlier, from the log count of the fresh pooled inoculum, as described earlier.

The higher the log count reduction the stronger the preservation action of the tested liquid cleaning composition.

### Examples

The following compositions were prepared by simple mixing. All the examples comprised the same level of surfactant.

The composition of inventive example 1 of table 1 comprised a branched C12 to C13 alkyl sulfate anionic surfactant and alkyl polyglucoside nonionic surfactant, in addition to lactic acid. The composition of comparative example A was the same as inventive example 1 except that the composition comprised a betaine surfactant instead of the alkyl polyglucoside surfactant. The comparative composition of example B was the same as comparative example A, except that it comprised an alkyl ethoxylated sulfate anionic surfactant instead of an alkyl sulfate anionic surfactant.

Comparative example C of table 2 comprised the linear alkyl sulfate anionic surfactant and betaine co-surfactant in a weight ratio of 2.41:1. The composition did not comprise any alkyl polyglucoside surfactant. Comparative example D of table 2 comprised alkyl polyglucoside, with the linear alkyl sulfate anionic surfactant and betaine co-surfactant present in the same ratio but at a reduced level, in order to have the same overall level of surfactant as comparative example C.

TABLE 1
Comparative and inventive liquid hand
dishwashing detergent compositions:

| wt % (100% active basis) | Ex 1 | Ex A | Ex B |
|---|---|---|---|
| Total Surfactant Level | 19.8 | 19.8 | 19.8 |
| C12-C13 alkyl ethoxylated (av. EO2.0) | — | — | 14.0 |
| sulfate (18% branching)¹ | | | |
| C12-C13 alkyl sulfate (18% branching)² | 14.0 | 14.0 | — |
| Alkyl polyglucoside³ | 5.8 | — | — |
| Cocoamidopropyl betaine | — | 5.8 | 5.8 |
| Lactic Acid | 2.0 | 2.0 | 2.0 |
| Ethanol | 3.8 | 3.8 | 3.8 |
| Perfume | 0.4 | 0.4 | 0.4 |
| pH | 3.4 | 3.4 | 3.4 |
| Log count reduction for 50% diluted | 4.3 | 2.8 | 1.7 |
| composition with deionized water after | | | |
| 5 minutes | | | |
| Log count reduction for neat | 5.0 | 4.5 | 1.9 |
| composition after 5 minutes | | | |

¹Sulfated Neodol ® 23-2 ethoxylated alkyl alcohol, the ethoxylated alcohol was supplied by Shell and sulfated by Procter & Gamble
²Sulfated Neodol ® 23 alkyl alcohol, alkyl alcohol supplied by Shell and sulfated by Procter & Gamble
³supplied by BASF, under the tradename Glucopon ® 600CSUP

TABLE 2
Comparative and inventive liquid hand
dishwashing detergent compositions:

| wt % (100% active basis) | Ex C* | Ex D* |
|---|---|---|
| Total Surfactant Level | 19.8 | 19.8 |
| Anionic surfactant/co-surfactant ratio | 2.41:1 | 2.41:1 |
| C12-C14 alkyl sulfate (linear)⁴ | 14.0 | 10.0 |
| C12-14 alkyl polyglucoside³ | — | 5.7 |
| Cocoamidopropyl betaine | 5.8 | 4.1 |
| Lactic Acid | 2.0 | 2.0 |
| Ethanol | 3.8 | 3.8 |
| Perfume | 0.4 | 0.4 |
| pH | 3.4 | 3.4 |
| Log count reduction for 50% diluted | 3.9 | 2.8 |
| composition after 5 minutes | | |
| Log count reduction for neat | 5.0 | 3.7 |
| composition after 5 minutes | | |

⁴Tensopol ® S30LSHPH, supplied by KLK Oleo

From comparing the log count reduction from comparative example C to that from comparative example B, it can be seen that compositions comprising linear alkyl sulfate anionic surfactant have improved antimicrobial efficacy in comparison to similar compositions which comprise branched alkyl sulfate anionic surfactant, at least when the composition does not further comprise alkyl polyglucoside. However, such compositions as comparative example C have reduced phase stability, especially at low temperatures, in comparison to equivalent compositions such as comparative example B, comprising branched alkyl sulfate anionic surfactant, since branching of the alkyl sulfate anionic surfactant is known to enhance low temperature stability.

From comparing the log count reduction from inventive example 1 to that of comparative example A, the improved antimicrobial efficacy of lactic acid containing liquid hand dishwashing compositions which comprise alkyl polyglucoside in addition to (non-alkoxylated) alkyl sulfate anionic surfactant can be seen (in contrast to a composition which comprises a betaine instead of the alkyl polyglucoside). The log count is even further reduced when single variably replacing (non-alkoxylated) alkyl sulfate anionic surfactant with ethoxylated alkyl sulfate anionic surfactant (comparative example B versus comparative example A).

However, as can be seen from comparing the log count reduction from comparative example D to that from comparative example C, it can be seen that the incorporation of alkyl polyglucoside, while maintaining the total surfactant level, resulted in a reduced log count reduction, both for the diluted compositions, and when used neat.

As such, the data shows that formulating the liquid hand dishwashing composition to comprise both the branched alkyl sulfate anionic surfactant and alkyl polyglucoside nonionic surfactant results in both good antimicrobial efficacy of the composition, and good low temperature stability.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any disclosure or claims herein or that it alone, or in any combination with any other reference or references, teaches, suggests or discloses any such disclosure. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

What is claimed is:

1. A liquid hand dishwashing composition comprising: from about 5% to about 50% by weight of the total composition of a surfactant system, wherein the surfactant system comprises:
a) anionic surfactant, wherein the anionic surfactant comprises at least about 50% by weight of the anionic surfactant of alkyl sulfated anionic surfactant, wherein: the alkyl sulfated anionic surfactant has an average degree of alkoxylation of about 1.0 or less,
the alkyl sulfated anionic surfactant has a weight average degree of branching of at least about 15%; and
b) an alkyl polyglucoside surfactant; and
wherein:
the composition further comprises a carboxylic acid and/or a salt thereof, wherein the carboxylic acid and/or a salt thereof comprises lactic acid and/or a salt thereof; and
the composition has a pH of less than about 5.0, measured as an about 10% solution in demineralized water at about 20° C.

2. The composition according to claim 1, wherein the liquid hand dishwashing detergent composition comprises from about 8.0% to about 45% by weight of the total composition of the surfactant system.

3. The composition according to claim 1, wherein the surfactant system comprises at least about 40% by weight of the surfactant system of the anionic surfactant.

4. The composition according to claim 1 wherein the anionic surfactant is present at a level of from about 5.0% to about 30% by weight of the composition.

5. The composition according to claim 1, wherein the anionic surfactant comprises at least about 70% by weight of the anionic surfactant of alkyl sulfated anionic surfactant.

6. The composition according to claim 5, wherein the anionic surfactant consists of the alkyl sulfated anionic surfactant.

7. The composition according to claim 1, wherein the anionic surfactant further comprises sulfonate anionic surfactant.

8. The composition according to claim 7, wherein the anionic surfactant is a mixture of the alkyl sulfated anionic surfactant and the sulfonate anionic surfactant.

9. The composition according to claim 1, wherein the alkyl sulfated anionic surfactant has an alkyl chain comprising an average of from 8 to 18 carbon atoms.

10. The composition according to claim 1, wherein the alkyl sulfated anionic surfactant has an average degree of alkoxylation of less than about 0.7.

11. The composition according to claim 10, wherein the alkyl sulfated anionic surfactant is free of alkoxylation.

12. The composition according to claim 1, wherein the alkyl sulfated anionic surfactant has a weight average degree of branching of from about 20% to about 60%.

13. The composition according to claim 1, wherein the alkyl polyglucoside is present at a level of from about 0.1% to about 10% by weight of the composition.

14. The composition according to claim 1, wherein the alkyl polyglucoside surfactant has an alkyl chain comprising an average length of from 8 to 18 carbon atoms, and a number average degree of polymerization of from about 0.1 to about 3.0.

15. The composition according to claim 1, wherein the composition further comprises a co-surfactant selected from amphoteric surfactant, zwitterionic surfactant, and mixtures thereof.

16. The composition according to claim 15, wherein co-surfactant is a betaine surfactant selected from the group consisting of alkyl betaines, alkylamidoalkylbetaine, amidazoliniumbetaine, sulphobetaine (INCI Sultaines), phosphobetaine, and mixtures thereof.

17. The composition according to claim 16, wherein the co-surfactant is present at a level of from about 0.1% to about 20% by weight of the composition.

18. The composition according to claim 1, wherein the lactic acid and/or a salt thereof is present at a level of from about 0.1% to about 10% by weight of the composition.

19. A method of cleaning dishes, the method comprising the step of contacting dishware with a liquid hand dishwashing detergent composition according to claim 1.
